(19) United States
(12) Patent Application Publication
(10) Pub. No.: US 2009/0195942 A1
(43) Pub. Date: Aug. 6, 2009

(54) Effect of a loss of a reactive impedance of a transformer, when secondary windings of the transformer are short circuited. The Method and the Device for a reduction of a short circuit currents

(76) Inventor: VALERI KARATCHOUN, PLAYA VISTA, CA (US)

Correspondence Address: Valeri Karatchoun, 5399 Playa Vista Dr. E424, Playa Vista, CA, 90094, US

(21) Appl. No.: 12/340,741

(22) Filed: Dec. 22, 2008

Related U.S. Application Data
(60) Provisional application No. 61/025,822, filed on Feb. 4, 2008.

(51) Int. Cl. H02H 7/04

(52) U.S. Cl. 361/38

(57) ABSTRACT

Transformers, like series reactors, have the quality to limit the short-circuit currents to values determined by the transformer's impedance which consist of the resistance and the inductive reactance.

Disclosed are a device and a method, that under the short-circuit conditions of secondary windings, with applied rated voltage to primary windings of a step-down transformer or with turns ratio 1:1, is the way of significant reducing of short-circuit currents in primary and secondary windings, as well in any output circuits connected to the transformer.

Disclosed is, a discovery of a self loss of a reactive impedance of the transformer windings, when the secondary windings of the transformer are short circuited, and a method of reducing of the short-circuit current of a short-circuited or ground-faulted transformer.

### BACKGROUND OF THE INVENTION

1. Field of the Invention

The present invention relates to the processes of changes of currents of step-down transformers, caused by changes of the load connected to the secondary winding of transformer.

2. Brief Description of Prior Art

For primary windings:

E₁=4.44W₁Fφ10⁻⁸

Where:

E₁ is an electromotive force of primary winding (Volt)

W₁ is a number of primary windings

F is a frequency of an electrical current flowing through a transformer windings (Hertz)

φ is a flux of a magnetic field (Maxwell)

For secondary windings:

E₂=4.44W₂Fφ10⁻⁸

Where:

E₂ is an electromotive force of secondary winding (Volt)

W₂ is a number of secondary windings

F is a frequency of electrical current flowing through transformer windings (Hertz)

φ is a flux of magnetic field (Maxwell)

I₁—a current of primary windings

I₂—a current of secondary windings

Currents, ‘I₁’ and ‘I₂’, flowing in transformer windings, besides a basic magnetic field ‘φ’, create dispersed (leakage) magnetic fields (φd₁ and φd₂.

Every of these dispersed (leakage) magnetic fields cuts only the windings of their own coils and induces there reactive EMF Ed₁ and Ed₂ of dispersing, which are directly proportional to their exciting currents ‘I₁’ and ‘I₂’.

−Ėd₁=İ₁·jx₁

−Ėd₂=İ₂·jx₂

Where x₁ and x₂ are inductive reactance (leakage inductances) of dispersing of primary and secondary windings of the transformer.

Thus in every transformer coil induces basic EMF and EMF of dispersing.

In primary winding EMF ‘E₁’ is EMF of a self-induction and E₁ is directed against an applied primary voltage.

The equation of EMF for primary windings is

U₁=(−Ė₁)+(−Ėd₁)+İ₁r₁

Or

U₁=(−Ė₁)+İ₁·jx₁+İ₁r₁

Where I₁·jx₁ and I₁r₁ are voltage drops in primary windings.

In common, voltages İ₁·jx₁ and İ₁r₁ are of a relatively little size, and it is true to consider, that voltage U₁ counterbalances EMF E₁.

U₁=(−Ė₁)

In secondary windings EMF ‘E₂’ acts as a current source, and the equation of EMF for secondary windings is

Ė₂=U₂+(−Ėd₂)+İ₂_{₂}r₂

Or

U₂=Ė₂−İ₂·jx₂−İ₂r₂

Where I₂·jx₂ and I₂r₂ are voltage drops in secondary windings and U₂ is an output voltage on secondary windings.

In common, voltages I₂·jx₂ and I₂r₂ are of a relatively little, and it is true to consider, that a voltage U₂counterbalances EMF Ė₂.

U₂=(−Ė₂)

If secondary windings are short circuited, then

U₂=0

and

Ė₂=İ₂·jx₂+İ₂r₂

consequently

İ₂=Ė₂/(jx₂+r₂)

4.44W₂Fφ10⁻⁸=İ₂·(jx₂+r₂)

φ=İ₂·(jx₂+r₂)/4.44W₂F10⁻⁸

As an impedance of dispersing is a relatively small, then I₂, under short circuited conditions of secondary windings, becomes a relatively very large. As result, of an electro-magnetic induction current of the transformer, I₁ becomes bigger, proportionally to the transformer turns ratio.

The expression for primary windings current is:

İ₁=İ₀+(−İ′₂)

Where:

İ₀ is an excitation current of no load (open circuit) transformer or a primary magnetizing-flux current (usually 2-10% of nominal primary current).

İ′₂=İ₂×(W₂/W₁) is current of secondary windings reflected to numbers of windings of primary coil.

I′₂ compensates demagnetizing action of secondary windings current.

Any change in a secondary current is followed by an appropriate change in a primary current. Thus the size of a magnetic flux φ, and hence EMF E₁ stay practically unchangeable.

U₁=(−Ė₁)+İ₁·jx₁+İ₁r₁−Ė₁=İ₂·jxₘ

Where xₘ is a mutual reactance, and

U₁=İ₂·jxₘ+İ₁·jx₁+İ₁r₁

As

Ė₂=İ₂·jx₂+İ₂r₂ then

İ₂=Ė₂/(jx₂+r₂) and

U₁=jxₘĖ₂/(jx₂+r₂)+İ₁·(jx₁+r₁)

As

Ė₂=İ₁·jxₘ then

U₁=İ₁·xₘ²/(jx₂+r₂)+İ₁·(jx₁+r₁)

U₁İ₁_{₁}·[xₘ²/(jx₂+r₂)+(jx₁+r₁)]

İ₁=U₁/[xₘ²/(jx₂+r₂)+(jx₁+r₁)]

For a secondary current

İ₁·jxₘ+İ₂·jx₂+İ₂r₂=0

So we have two equations:

İ₂·jxₘ+İ₁·jx₁+İ₁r₁=U₁

İ₁·jxₘ+İ₂·jx₂+İ₂r₂=0

### SUMMARY OF THE INVENTION

Solving these equations correspondingly to İ₁, we have

İ=U₁/[(r₁+rᵢₙ)+j(x₁−xᵢₙ)]

Here we have

rᵢₙ=xₘ²r₂/(r₂²+x₂²)

xᵢₙ=xₘ²x₂/(r₂²+x₂²)

Where rᵢₙ and xᵢₙ are (I have named) an inserted resistance and reactance which should be inserted in series in primary windings circuit in order to cancel influence of short-circuited secondary windings on a current in circuit of primary windings of the transformer.

I claim that inserting an impedance of certain size in series with primary windings, we reduce a short circuit current in windings of a short-circuited transformer accordingly to the size of the inserted impedance and the size of an impedance of a short-circuited transformer.

Thus I claim, when using my proposed circuit, a short current will be reduced significantly much, as well a danger of electrocution, and equipment damages caused by short circuits, for any level of the applied voltage.

Even if, having only an active resistance in series with primary, the short circuit current in primary and secondary windings drops to minimum level.

Having a temperature dependant resistance in series with primary coil of not short-circuited transformer, with impedance of this inserted resistance much smaller, than an impedance of primary windings of working transformer, the input voltage most applies to transformer, and only a small part of the input voltage is dropped on an inserted resistance, directly proportional to the sizes of their impedances.

So this transformer is working with all nominal parameters on primary and secondary windings. But when secondary windings is short-circuited, most of the input voltage becomes applied to the inserted resistance, and only a small part of the input voltage is dropped on primary windings of transformer, as the transformer have lost its reactance, and its impedance greatly decreased.

Correspondingly having a smaller dropped voltage on the transformer, I have a smaller current flowing through the windings of the transformer. Thus the amount of a short-circuit current through any windings of the transformer under short circuited secondary windings conditions is defined only by the size of an active resistance of any windings of the transformer with turns ratio 1:1, due to self-reduction of the reactive impedance of the transformer, because of flow of short circuit current in secondary windings of a transformer.

For a step-down transformer the amount of a short-circuit current through any windings of the transformer, under short-circuited secondary windings conditions is defined by the size of an active resistance of any windings of the transformer and the transformer turns ratio, due to self-reduction of the reactive impedance of the transformer.

The process of changing currents in the transformer before and after when short circuit of secondary transformer winding happened is described in the drawings of this invented device.

The device shown in drawings used to limit the current in short-circuited 120 v circuits significantly in residential, commercial, industrial, or any 120 v circuits. Using this device allowed us to limit significantly the danger of electrocution in most common circuits 120 v, if some person accidentally touched the hot (phase) wire of the circuit, and became fault grounded.

In order to use this device for any higher voltage, like for example 277 v, the only thing that I have to change, is to use 277 v transformer and other parts rated for 277 v.

For better use of this method, the device must have transformer turns ratio 1:1. The 1:1 ratio allowed 100% of possible reducing of a reactance impedance of the transformer windings. Undoubtedly, that my invented method of reducing short circuit currents, also is for use for any voltages higher or less than 1000 volts.

### BRIEF DESCRIPTION OF THE DRAWINGS

FIG. 1 is a scheme of the device for 120 v. circuit, when there is no load in the output circuit.

FIG. 2 is a scheme of the device for 120 v. circuit, when the output circuits are shorted.

FIG. 3 is a scheme of the device for 120 v. circuit to protect output circuits against shortage and ground faults, when there is no shortage in the output circuits.

FIG. 4 is a scheme of the device for 120 v. circuit to protect output circuits against shortage and ground faults, when there is shortage in the output circuits.

### DESCRIPTION OF THE PREFERRED EMBODIMENTS

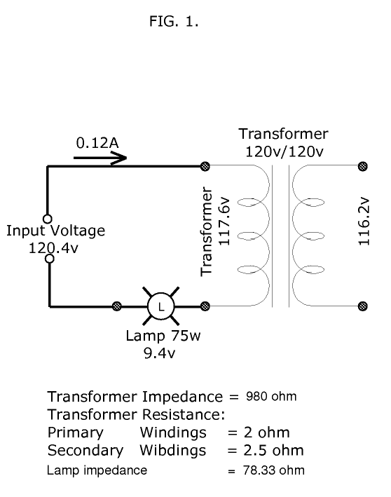

Referring to FIG. 1 there is shown a 120 v. transformer (turns ratio 1:1) with an input voltage 120 v. and no load connected to the secondary windings. Secondary windings are open. There is an temperature dependant resistance which is an electrical lamp (75 w, 120 v) in series with the transformer primary.

There are 120.4 v. input voltage and 11 7.6 v. on the transformer primary, because of voltage drop 9.4 v. in electrical bulb resistance and self-inductance of transformer. The current flowing in an input circuit is 0.12 a. The output voltage in the transformer secondary is 116.2 v.

The transformer impedance is 980 ohm. A primary windings resistance is 2 ohm. A secondary windings resistance is 2.5 ohm. The lamp impedance (resistance) is 78.33 ohm.

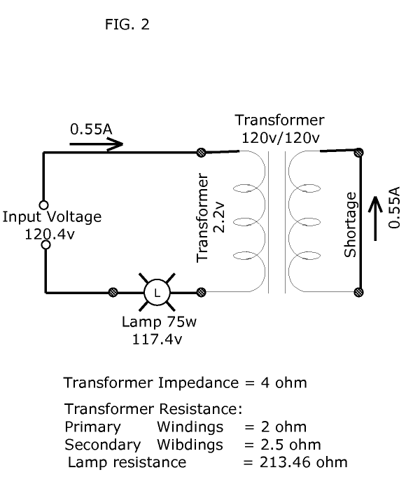

The circuit of drawing FIG. 2 is with corresponding elements similar to that of FIG. 1. Referring to FIG. 2, the circuit depicted with transformer secondary windings shorted, differs from that of FIG. 1. The current flowing through the shorted transformer secondary is equal to the current flowing through the transformer primary, which is only 0.55 A.

The input voltage to this scheme is 120.4 v, same as in FIG. 1. The voltage drop in the resistance of the electrical bulb is 117.4 v. The voltage to the primary windings (which impedance is greatly reduced because of lost of transformer reactance and equals now to 4 ohm, you compare with the impedance 980 ohm of the scheme of FIG. 1) is 2.2 v. Thus having an active temperature dependant impedance (resistance) equaled, for this scheme, to 53 times bigger, than a transformer impedance, in series with a transformer primary, I reduced a short circuit current practically to minimum definitely defined by a resistance in series with the transformer primary and a resistance of the transformer primary.

This FIG. 2 diagram greatly differs from so called a transformer short circuit test, which is when, the secondary terminals of transformer are shorted, and the primary voltage is increased from zero until the rated current is reached in the primary. At this point the primary voltage is measured. It is much less than rated voltage and is calculated in percents. This percentage represents the amount of normal rated primary voltage which must be applied to the transformer to produce full rated load current when the secondary winding is short circuited. The maximum short circuit current that can be obtained from the output of the transformer is limited by the impedance of the transformer and is determined by the multiplying the reciprocal of the impedance timed the full load current. Thus, if a transformer has 5% impedance, the reciprocal of 0.05 is 20 and maximum short circuit current is 20 times the full load current. It is clear seen, this device, the scheme (diagram) of the device, all of these, that I invented;

1) allow a transformer with rated voltage to work with shorted secondary coil of transformer.

2) protect transformer, equipment connected to it and people against any short circuits and ground faults in transformer, and as well in any output circuits connected to secondary coil of any transformer.

Without my invented device any transformer that works short-circuited with applied rated primary voltage would carry an enormous current. It would become red hot within a few seconds. The transformer would be destroyed. Use of my invention lets any transformer to become a self-short-current-minimized in any windings of a transformer or output circuits. It is clear seen, that with my invention, short circuited transformer currents are only, (for FIG. 2) 0.55 A in primary and secondary windings. It is clear seen the difference against any shorted transformer, which is working without my invention and having hundreds or thousands amperes of currents in its windings.

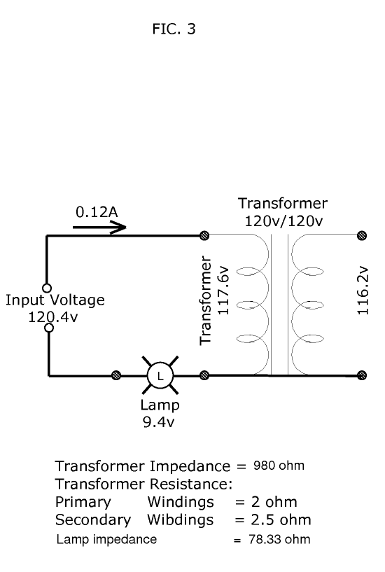

The circuit of drawing FIG. 3 is with corresponding elements similar to that of FIG. 1.

Referring to FIG. 3, the circuit depicted with transformer secondary windings terminals are open, differs from that of FIG. 1. Transformer shown in the drawing of FIG. 3 has electrical connection between primary and secondary windings of transformer. The diagram of device of FIG. 3 is used to protect the transformer, connected equipment, and people against ground faults. The secondary windings are open.

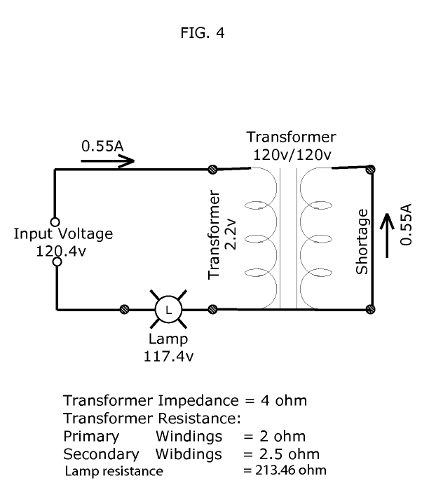

Referring to FIG. 4, the circuit depicted with transformer secondary windings terminals are closed, differs from that of FIG. 1. Transformer shown in the drawing of FIG. 4 has electrical connection between primary and secondary windings of transformer.

The diagram of device of FIG. 4 is used to protect the transformer, connected equipment, and persons against ground faults, when ground fault or short circuit happened.

The secondary windings are shorted.

It should thus be clear that the practice of this invention is not limited to the precise forms shown in the examples of one phase transformer selected for illustration and that still further embodiments of this invention are possible within the scope of the appended claims for any transformers or circuits, including multi phase or one phase transformers or circuits working with any applied nominal voltage from below 1000 v to above 1000 v.

What is claimed is:

1. A short-circuit current and ground fault sensitive, current self-regulated system, which is connected to supply conductors from a source of electricity.
a) a short-circuit current and ground fault sensitive, current self-regulated system for reducing a short-circuit current after self-detecting of short circuits in secondary transformer windings or electrical circuits connected to the transformer secondary windings.
b) a short-circuit current sensitive, current self-regulated system with possible electrical connection of the transformer secondary winding to the transformer primary winding for self-detection of a ground fault and ground fault current reduction in the transformer secondary windings or electrical circuits connected to the transformer secondary windings.
c) a short-circuit current and ground fault sensitive, current self-regulated system for transformer, equipment and personal protection.

2. Proof of self-loss (self reduction) of transformer reactance due to process of flowing of short circuit current in secondary windings of a transformer.
a) Self-loss (self reduction) of a transformer reactance after secondary winding of a transformer is shorted, with any, from minimum to maximum primary voltage applied to the transformer.
b) Reduction of a transformer impedance of primary and secondary transformer windings due to self-loss of transformer reactance after secondary winding of transformer is shorted, with any, from minimum to maximum primary voltage applied to the transformer.

3. A power supply circuit having output short circuit protection, comprising:
a) A step down transformer or transformer with turns ratio 1:1, having a primary winding connected to an AC power supply, a secondary winding, and an impedance connected in series with the primary winding.
b) A resistor, which resistance is temperature defendant and increases when temperature of a resistor goes up, connected in series with the primary windings. An electrical bulb, as an example.
c) An impedance, which impedance is temperature or voltage defendant and increases, when voltage on it goes up, connected in series with the primary windings of a transformer.
d) A connection of an impedance, which is temperature or voltage dependant and increases when voltage or temperature on it goes up, in series with primary windings of a power supply step down transformer, or transformer with turns ratio 1:1, for reduction of voltage on the leads of a primary winding of the transformer.
e) An electrical connection of primary windings to a secondary windings of a transformer.

4. (canceled)

5. (canceled)

6. (canceled)
